(19) United States
(12) Patent Application Publication
(10) Pub. No.: US 2025/0190440 A1
(43) Pub. Date: Jun. 12, 2025

(54) EMOTION ESTIMATION APPARATUS, METHOD, AND PROGRAM

(71) Applicant: NIPPON TELEGRAPH AND TELEPHONE CORPORATION, Tokyo (JP)

(72) Inventors: Rika MOCHIZUKI, Musashino-shi (JP); Ryuji YAMAMOTO, Musashino-shi (JP)

(73) Assignee: NIPPON TELEGRAPH AND TELEPHONE CORPORATION, Tokyo (JP)

(21) Appl. No.: 18/843,312

(22) PCT Filed: Mar. 9, 2022
(86) PCT No.: PCT/JP2022/010390

§ 371 Date: Sep. 3, 2024

(51) Int. Cl. G06F 16/2457

(52) U.S. Cl. CPC G06F 16/24575

(57) ABSTRACT

An emotion estimation apparatus according to an embodiment includes an estimation unit that extracts a prediction degree corresponding to a scene that is currently related to a user and indicating a magnitude of a possibility that a first situation changes to a second situation and an expectation degree indicating a magnitude of an expectation of the user for the change, extracts at least one of a knowledge amount and an experience amount of the user corresponding to the scene that is currently related to the user, and estimates an emotion generation amount indicating a strength of an emotion expression generated at the time of the change, on the basis of the extracted results.

### TECHNICAL FIELD

An embodiment of the present invention relates to an emotion estimation apparatus, method, and program.

### BACKGROUND ART

In Non Patent Literature 1, a method for examining and collecting a situation where an emotion of a user occurs and systematically classifying the situation is disclosed. Furthermore, Patent Literature 1 discloses a method for modeling and estimating an emotion from a life log in which a record of a user's life is managed. Similarly, Non Patent Literature 2 discloses a method for assisting communication using a modeled emotion.

### CITATION LIST

### Patent Literature

Patent Literature 1: JP 2013-105232 A

### Non Patent Literature

Non Patent Literature 1: Situations and cognitive appraisals in ‘agari’ experiences: Feature analyses of ‘agari’ experiences, Arimitsu et al., The Japanese Journal of Psychology, Vol 70, No 1, pp 30-37, 1999
Non Patent Literature 2: Emotion Sharing Model based on Life-Log Comparison-Matching comparable experiences-, Rika Mochizuki & Tomoki Watanabe, The Transactions of Human Interface Society, Vol. 11, pp. 79-92, 2016.

### SUMMARY OF INVENTION

### Technical Problem

However, in the method disclosed in Non Patent Literature 1 described above, it is possible to handle an instantaneous emotion associated with an event such as “feeling tension in an interview”, for example. However, for example, it is not possible to handle a difference degree of the emotion caused by each user's experience such as “feeling tension in a first interview”.

Furthermore, in methods disclosed in Patent Literature 1 and Non Patent Literature 2, for example, a feature of an event itself and an emotion are associated, for example, like “music live=fun”, and it is difficult to estimate an emotion in a first event. Furthermore, with these methods, a difference degree of the emotion caused by knowledge of a user, for example, “more fun as a live of an artist who is familiar from long ago” is not considered.

This invention has been made in view of the above circumstances, and an object of the present invention is to provide an emotion estimation apparatus, method, and program that enable to appropriately estimate an emotion of a user.

### Solution to Problem

An emotion estimation apparatus according to one aspect of the present invention that estimates an emotion generated by a user, using first management information in which a first situation, a second situation changed from the first situation, emotion information representing an emotion expression of the user when the first situation changes to the second situation, a prediction degree indicating a magnitude of a possibility that the first situation changes to the second situation, and an expectation degree indicating a magnitude of an expectation of the user for the change from the first situation to the second situation are managed together with information indicating a scene related to the user, second management information in which at least one of a knowledge amount indicating an amount of knowledge of the user for the scene and an experience amount indicating an amount of experience of the user for the scene is managed, and third management information in which a calculation definition of an emotion generation amount indicating a strength of an emotion expression generated by the user when the first situation changes to the second situation, based on the prediction degree, the expectation degree, and the second management information is managed together with the information indicating the scene, and the emotion estimation apparatus includes an estimation unit that extracts the prediction degree corresponding to the scene currently related to the user and the expectation degree, from the first management information, extracts the second management information corresponding to the currently related scene, and estimates the emotion generation amount indicating the strength of the emotion expression generated by the user when the first situation changes to the second situation, on the basis of the extracted results and the calculation definition of the emotion generation amount corresponding to the scene currently related to the user.

An emotion estimation apparatus according to one aspect of the present invention that estimates an emotion generated by a user, using first management information in which a first situation, a second situation changed from the first situation, emotion information representing an emotion expression of the user when the first situation changes to the second situation, a prediction degree indicating a magnitude of a possibility that the first situation changes to the second situation, and an expectation degree indicating a magnitude of an expectation of the user for the change from the first situation to the second situation are managed together with information indicating a scene related to the user, second management information in which at least one of a knowledge amount indicating an amount of knowledge of the user for the scene and an experience amount indicating an amount of experience of the user for the scene is managed, and third management information in which a calculation definition of an emotion generation amount indicating a strength of an emotion expression generated by the user when the first situation changes to the second situation, based on the prediction degree, the expectation degree, and the second management information is managed together with the information indicating the scene, and the emotion estimation apparatus includes an estimation unit that extracts the prediction degree corresponding to emotion information representing an emotion expression that the user desires to share with other person and the expectation degree, from the first management information, extracts the information managed together with the extracted results in the first management information, extracts management information in which at least one of the knowledge amount and the experience amount in the second management information corresponding to the extracted scene satisfies a condition, and estimates the emotion generation amount indicating the strength of the emotion expression generated by the user, on the basis of the extracted prediction degree, the expectation degree, the extracted second management information, and the calculation definition of the emotion generation amount.

An emotion estimation method according to one aspect of the present invention performed by an emotion estimation apparatus that estimates an emotion generated by a user, using first management information in which a first situation, a second situation changed from the first situation, emotion information representing an emotion expression of the user when the first situation changes to the second situation, a prediction degree indicating a magnitude of a possibility that the first situation changes to the second situation, and an expectation degree indicating a magnitude of an expectation of the user for the change from the first situation to the second situation are managed together with information indicating a scene related to the user, second management information in which at least one of a knowledge amount indicating an amount of knowledge of the user for the scene and an experience amount indicating an amount of experience of the user for the scene is managed, and third management information in which a calculation definition of an emotion generation amount indicating a strength of an emotion expression generated by the user when the first situation changes to the second situation, based on the prediction degree, the expectation degree, and the second management information is managed together with the information indicating the scene, and the emotion estimation method includes, by an estimation unit of the emotion estimation apparatus, extracting the prediction degree corresponding to the scene currently related to the user and the expectation degree, from the first management information, extracting the second management information corresponding to the currently related scene, and estimating the emotion generation amount indicating the strength of the emotion expression generated by the user when the first situation changes to the second situation, on the basis of the extracted results and the calculation definition of the emotion generation amount corresponding to the scene currently related to the user.

An emotion estimation method according to one aspect of the present invention performed by an emotion estimation apparatus that estimates an emotion generated by a user, using first management information in which a first situation, a second situation changed from the first situation, emotion information representing an emotion expression of the user when the first situation changes to the second situation, a prediction degree indicating a magnitude of a possibility that the first situation changes to the second situation, and an expectation degree indicating a magnitude of an expectation of the user for the change from the first situation to the second situation are managed together with information indicating a scene related to the user, second management information in which at least one of a knowledge amount indicating an amount of knowledge of the user for the scene and an experience amount indicating an amount of experience of the user for the scene is managed, and third management information in which a calculation definition of an emotion generation amount indicating a strength of an emotion expression generated by the user when the first situation changes to the second situation, based on the prediction degree, the expectation degree, and the second management information is managed together with the information indicating the scene, and the emotion estimation method includes, by an estimation unit of the emotion estimation apparatus, extracting the prediction degree corresponding to emotion information representing an emotion expression that the user desires to share with other person and the expectation degree, from the first management information, extracting the information managed together with the extracted results in the first management information, extracting management information in which at least one of the knowledge amount and the experience amount in the second management information corresponding to the extracted scene satisfies a condition, and estimating the emotion generation amount indicating the strength of the emotion expression generated by the user, on the basis of the extracted prediction degree, the expectation degree, the extracted second management information, and the calculation definition of the emotion generation amount.

### Advantageous Effects of Invention

According to the present invention, it is possible to appropriately estimate an emotion of a user.

### BRIEF DESCRIPTION OF DRAWINGS

FIG. 1 is a diagram illustrating an application example of an emotion estimation apparatus according to a first embodiment of the present invention.

FIG. 2 is a diagram illustrating an example of a functional configuration of a DB input unit.

FIG. 3 is a diagram illustrating an example of an input screen related to a parameter (parameters) designation unit.

FIG. 4 is a diagram illustrating an example of content of a situation change list DB according to the first embodiment of the present invention in a table format.

FIG. 5 is a diagram illustrating an example of content of a life log DB in a table format.

FIG. 6 is a diagram illustrating an example of content of an emotion generation amount calculation definition DB in a table format.

FIG. 7 is a diagram illustrating an example of a procedure of a processing operation by the emotion estimation apparatus according to the first embodiment of the present invention.

FIG. 8 is a diagram illustrating an example of content of a situation change list DB according to a second embodiment of the present invention in a table format.

FIG. 9 is a diagram illustrating an example of a procedure of a processing operation by an emotion estimation apparatus according to the second embodiment of the present invention.

FIG. 10 is a block diagram illustrating an example of a hardware configuration of the emotion estimation apparatus.

### DESCRIPTION OF EMBODIMENTS

Hereinafter, an embodiment according to the present invention will be described with reference to the drawings.

In an embodiment of the present invention, emotion information (hereinafter, may be simply referred to as emotion) representing an emotion expression of a user generated caused by a change in a situation of the user and a degree of a strength of the emotion are modeled in accordance with knowledge and experience of the user. As a result, on the basis of the situation where the user is placed, it is possible to estimate the emotion and the degree of the strength of the emotion (degree of emotion) or promote empathy with others by reproducing and presenting a similar situation that is easily understood by the user.

In the present embodiment, all emotions caused by a change in the situation, for example, “wasteful”, “frustrating”, “excited”, or the like are targets. For example, an application to production in accordance with emotions of audience in various events such as a music live (may be simply referred to as live) or mutual understanding of emotions in remote or cross-cultural communication is assumed.

In the present embodiment, by considering a state before an emotion of each person occurs, for example, a knowledge amount, an experience amount, and an expectation degree to be described later, in addition to preceding and following situations of the situation where the user is placed, it is possible to estimate an emotion different for each person or a degree of a strength of the emotion at the moment when the emotion occurs.

As a result, by customizing a service in real time or presenting a similar situation that is easily understood by each person to a target, it can be expected to make the target understand and empathize how others feel.

For example, when the present embodiment is utilized for telemedicine, by grasping a “tension” when a patient interacts with a doctor from moment to moment, it is possible to use the present embodiment to improve psychological safety of the patient.

Furthermore, for example, when the present embodiment is utilized at the time of serving using a tablet or the like in a travel agency, a case in which a customer knows a satisfaction degree of others at a travel destination can be presented and understood.

### First Embodiment

Next, a first embodiment of the present invention will be described.

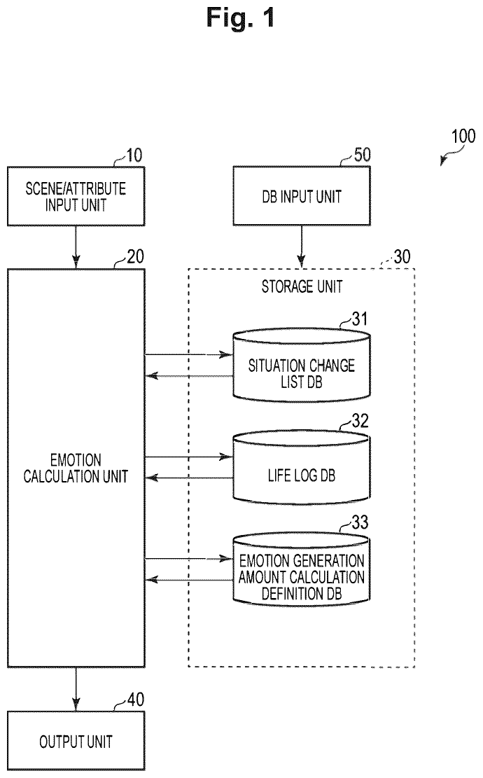

FIG. 1 is a diagram illustrating an application example of an emotion estimation apparatus according to the first embodiment of the present invention.

As illustrated in FIG. 1, an emotion estimation apparatus 100 according to the first embodiment of the present invention includes a scene/attribute input unit 10, an emotion calculation unit (emotion estimation unit) 20, a storage unit 30, an output unit 40, and a database (DB) input unit 50.

In the storage unit 30, a situation change list DB 31, a life log DB 32, and an emotion generation amount calculation definition DB 33 are provided as various DBs. Details of each unit illustrated in FIG. 1 will be described later.

In the present embodiment, it is assumed that information in the situation change list DB 31, the life log DB 32, and the emotion generation amount calculation definition DB 33 be created in advance and various DBs be constructed, by an operation related to the DB input unit 50 by a service provider that uses the emotion estimation apparatus 100.

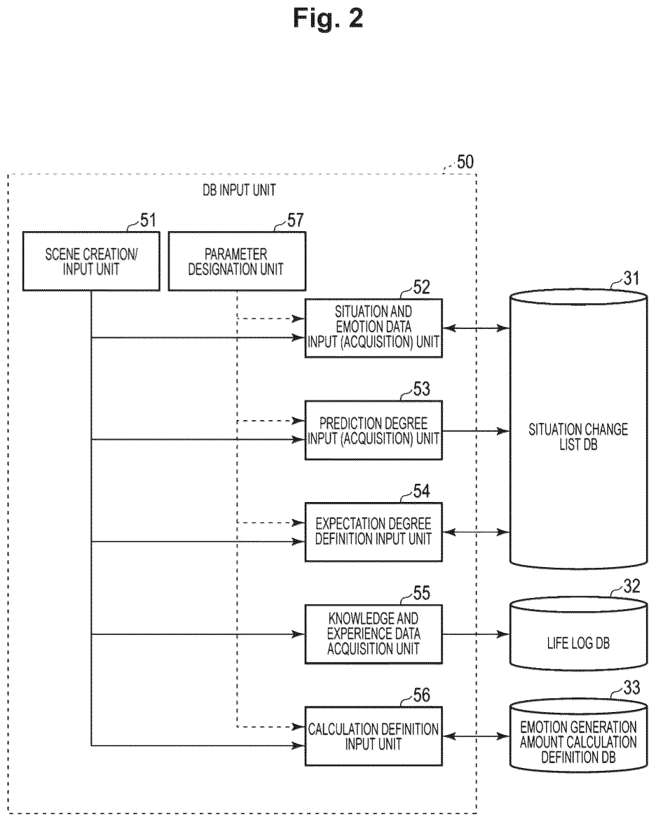

FIG. 2 is a diagram illustrating an example of a functional configuration of the DB input unit.

The DB input unit 50 receives an input operation of the information related to the situation change list DB 31, the life log DB 32, and the emotion generation amount calculation definition DB 33 on a user interface (UI) for input/output, by the service provider.

As illustrated in FIG. 2, the DB input unit 50 includes a scene creation/input unit 51, a situation and emotion data input (acquisition) unit 52, a prediction degree input (acquisition) unit 53, an expectation degree definition input unit 54, a knowledge and experience data acquisition unit 55, a calculation definition input unit 56, a parameter designation unit 57. Details of each unit in the DB input unit 50 will be described later.

The scene/attribute input unit 10 illustrated in FIG. 1 can input information indicating a scene where a user is placed, for example, “contents browsing” as a large classification of the scene, “music live” as a medium classification of the scene, and “ox stars” (music artist name) as a small classification of the scene, through an input or select on a screen by the user.

The information regarding the scene may be acquired by sensing or the like. Hereinafter, the input or acquired content is referred to as a scene.

An input method by the scene/attribute input unit 10 may be manual input of a scene on the UI screen or may be voice input using a voice recognition function or the like of a smart speaker. Furthermore, the user may select a desired scene from a pull-down menu displayed on the UI screen or may select a scene by voice input by the user from listed categories of various scenes.

Furthermore, the scene/attribute input unit 10 can extract a scene that matches input content by manual input of characters on the UI screen or voice or a scene that is the most similar to the input content, as a scene to be input. The scene/attribute input unit 10 can extract the similar scene, for example, by a method for preparing a name-based aggregation file in advance, and aggregating an input, for example, “festival”, “ox rock” (event name), “outdoor live”, or the like into a category of “music live”.

When information regarding a scene is acquired by the above sensing, if the large classification of the scene is content browsing, for example, the information regarding the scene may be automatically acquired from user's browsing information or the like in a personal computer (PC) or a television (TV). Furthermore, when position information is included in the large classification of the scene, the position information may be acquired from a mobile terminal.

Furthermore, the scene/attribute input unit 10 can automatically acquire an attribute of the user, for example, a personal identifier (ID) by manual input or selection on the UI screen or the mobile terminal by the user.

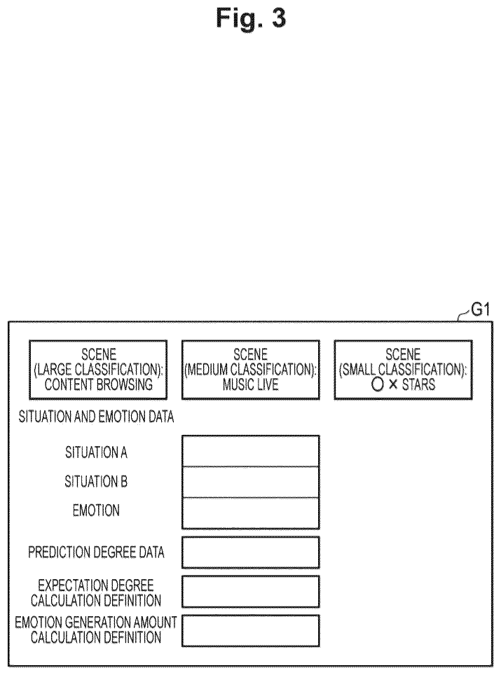

FIG. 3 is a diagram illustrating an example of an input screen related to the parameter designation unit.

The DB input unit 50 illustrated in FIG. 2 displays, on the UI screen, an input screen G1 of situation and emotion data, prediction degree data, calculation definition of an expectation degree (hereinafter, may be referred to as expectation degree calculation definition), and calculation definition of an emotion generation amount (hereinafter, may be referred to as expectation degree calculation definition), as parameters according to the input scene. In FIG. 3, the input screen G1 when “large classification/medium classification/small classification” of the input scene is “content browsing/music live/ox stars”.

The situation and emotion data includes “situation A” that is a situation before a change, “situation B” that is a situation changed from the “situation A”, and an emotion of the user. This emotion is an emotion expression of the user when the “situation A” is changed to the “situation B”.

By an input operation or the like on the UI screen by the service provider, the parameter designation unit 57 can designate a parameter in accordance with the input scene, in response to the input operation by the service provider.

The scene creation/input unit 51 of the DB input unit 50 receives the input operation on the UI screen by the service provider and creates a list of scenes that can be selected at the time when the user uses the emotion estimation apparatus 100, in accordance with the input operation. The list of the scenes includes the large classification of the scene, the medium classification of the scene, and the small classification of the scene.

The large classification of the scene is, for example, “content browsing” or the like and may include the position information. The medium classification of the scene is, for example, “music live”, “news/weather”, or “transportation means”, or the like. The small classification of the scene is, for example, “artist name”, “news category”, or the like, and there may be a case where this small classification is not set.

The classification of the scene is not limited to the above classification, and may be any structure classification, and the scene list may be created by citation from a document or the like or manual input on the UI screen by the service provider.

Next, input of the information in each DB, that is, the situation change list DB 31, the life log DB 32, and the emotion generation amount calculation definition DB 33 by each unit in the DB input unit 50 illustrated in FIG. 2 will be described.

In a state where the input screen G1 illustrated in FIG. 3 corresponding to the list of the scenes created by the scene creation/input unit 51 is displayed, the situation and emotion data input (acquisition) unit 52 inputs the situation and emotion data (may be referred to as situation and emotion data) by an operation on the parameter designation unit 57 and writes the data in the situation change list DB 31 as situation and emotion data related to a scene displayed on the input screen G1.

This situation and emotion data may be manually input on the input screen G1 or may be automatically acquired by crawling of Web information or the like.

In the present embodiment, as illustrated in FIG. 3, the situation and emotion data includes “situation A”, “situation B”, and “emotion”. The “situation A” is a situation where the user is placed, before the situation is changed to the “situation B” under a condition of a certain scene. The “situation B” is a situation where the user is placed, after the situation is changed from the “situation A” under the condition of the scene. The “emotion” is one or a plurality of emotion types, generated by the user when the “situation A” is changed to the “situation B” under the condition of the scene.

This situation and emotion data may be input after being extracted and aggregated by a general-purpose emotion analysis tool such as ML-Ask (for example, refer to https://gaaaon.jp/blog/mlask) from a text displayed by a social network service, for example, or a case where each emotion occurs may be collected from a questionnaire and may be input, as disclosed in Non Patent Literature 1 described above.

In a state where the input screen as illustrated in FIG. 3 is displayed, the prediction degree input (acquisition) unit 53 receives an input operation related to a prediction degree on the UI screen by the service provider and writes this prediction degree into the situation change list DB 31 as a prediction degree related to a scene displayed on the input screen.

The prediction degree indicates a magnitude of a possibility that a situation and an emotion in the situation and emotion data written into the situation change list DB 31 may occur and is, for example, a numerical value equal to or more than zero and equal to or less than one.

The prediction degree data may be manually input on the UI screen by the service provider or may be automatically acquired, for example, by an artificial intelligence (AI) chatbot or the like. In a case of manual input, for example, a probability that a new song is suddenly played in a music live, a probability that ballad songs are continuously played in a music live, or the like is examined in advance from information on the Web or the like, and a prediction degree in accordance with the examination result may be input.

In a state where the input screen as illustrated in FIG. 3 is displayed, the expectation degree definition input unit 54 receives an input operation related to the expectation degree calculation definition (may be referred to as expectation degree definition) on the UI screen by the service provider and writes the expectation degree calculation definition into the situation change list DB 31 as an expectation degree calculation definition related to a scene displayed on the input screen.

The expectation degree indicates a size of feeling of a user who desires that the situation and the emotion in the situation and emotion data written into the situation change list DB 31 occur, and is, for example, a numerical value equal to or more than zero and equal to or less than one.

When it does not matter for the user whether or not the situation and the emotion occur, the expectation degree is “0”, and when the user desires that the situation and the emotion occur, the expectation degree is “1”.

Furthermore, when the feeling includes a size of the feeling that it is desired that the situation and the emotion do not occur, the expectation degree is, for example, a numerical value equal to or more than “−1” and equal to or less than “1”.

Specifically, when the user desires that the situation and the emotion do not occur at any time, the expectation degree is “−1”, and in a case where it does not matter whether or not the situation and the emotion occur, the expectation degree is “0”. When the user desires that the situation and the emotion occur at any time, the expectation degree is “1”.

The expectation degree calculation definition may be set by manual input on the UI screen by the service provider or may be set by selection on a screen by the service provider. In the present embodiment, based on a degree indicating a strength of the expectation that the user desires that the “situation A” changes to the “situation B” under the condition of the certain scene, an expectation degree calculation formula using a knowledge amount T_U and an experience amount K_U as variables is set as the expectation degree calculation definition.

Furthermore, for example, a selection item such as “the more the knowledge and experience, the stronger the expectation” or “the more the knowledge and experience, the weaker the expectation” is displayed on the screen, and a calculation formula corresponding to an item selected by the service provider may be set as the expectation degree calculation definition.

The knowledge and experience data acquisition unit 55 acquires a knowledge amount and an experience amount for each scene, from sensing data, for example, a search history, a purchase history, or the like of the user, and accumulates acquisition results in the life log DB 32.

The knowledge amount and the experience amount are values obtained by parameterizing magnitudes of knowledge and experience of the user for the situation and the emotion in the situation and emotion data written into the situation change list DB 31 and are, for example, numerical values equal to or more than zero and equal to or less than one.

The calculation definition input unit 56 receives an input of a calculation formula used to calculate an emotion generation amount on the UI screen.

The emotion generation amount indicates a strength of an emotion generated by a user, when the situation changes from the “situation A” to the “situation B” under the condition of the certain scene, triggered by this change, and is, for example, a numerical value equal to or more than zero and equal to or less than one.

The emotion generation amount calculation definition may be set by manual input on the UI screen by the service provider or may be set by selection on the screen by the service provider.

Specifically, the emotion generation amount calculation definition may be set as an emotion generation amount calculation formula using some or all of a prediction degree Y, an expectation degree E_U, the knowledge amount T_U, the experience amount K_U, and an external factor G, as variables, and the calculated value indicates the strength of the emotion of the user when the “situation A” changes to the “situation B” under the condition of the certain scene.

Furthermore, for example, a selection item such as “the lower the prediction degree, the higher the expectation degree, and the more the knowledge and experience, the stronger the emotion”, “the higher the prediction degree and the lower the expectation degree, and the stronger the emotion”, or the like is displayed on the screen, and a calculation formula corresponding to an item selected by the service provider may be set as the emotion generation amount calculation definition.

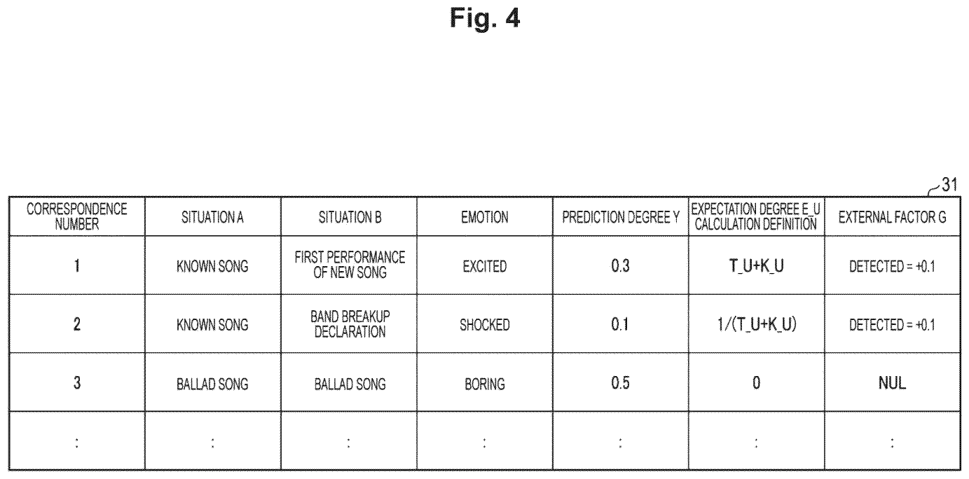

FIG. 4 is a diagram illustrating an example of content of the situation change list DB according to the first embodiment of the present invention in a table format.

In the situation change list DB 31 illustrated in FIG. 1 or the like, data created for each combination of scene classifications, that is, situation change list information including (1) the “situation A”, (2) “the situation B”, and (3) an “emotion” of the user when the situation changes from the “situation A” to the situation B″, (4) the “prediction degree Y” that is a probability that the situation changes from the “situation A” to the “situation B”, (5) the “expectation degree E_U calculation definition”, and (6) “the “external factor G” that affects the strength of the emotion, under the condition of the certain scene, as illustrated in FIG. 4 is created and accumulated for each combination of the classifications from the large classification to the minimum classification of all the scenes (directly, minimum classification of scenes). For example, when the small classification is not set, the situation change list information is created and accumulated for each combination of the large classification and the medium classification (directly, medium classification).

In FIG. 4, situation change list information when the “large classification/medium classification/small classification” of the input scene is the “content browsing/music live/ox stars” (refer to FIG. 3) is illustrated. Furthermore, each line in the situation change list information illustrated in FIG. 4 may be referred to as a record of the situation change list information. As illustrated in FIG. 4, an individual correspondence number (may be referred to as record number) is assigned to each line in the situation change list information.

The prediction degree Y is a magnitude of a possibility that the situation changes from the “situation A” to the “situation B” under the condition of the certain scene or a probability that the situation changes, and may be expressed by a value within a range of zero to one.

In the situation change list information, for example, if an emotion “wasteful” in a scene of “news” is set in the situation change list DB 31, for example, the prediction degree Y (for example, 0.27) as a frequency at which unsold food is discarded may be set to a record to which the emotion is set.

Furthermore, for example, if an emotion “wasteful” in a scene of “meeting” in the situation change list information is set in the situation change list DB 31, for example, the prediction degree Y (for example, 0.3) as a probability that a participant who has knowledge related to a speech miss a speech opportunity may be set to a record to which the emotion is set.

The external factor G is another element that affects a variation of the emotion generation amount. The external factor G is assumed as an element that strengthens or weakens the emotion of the user depending on, for example, presence or absence of (1) acquisition of prior prediction information indicating that the situation is changed from the “situation A” to the “situation B”, (2) a background music (BGM) when the situation occurs, (3) a speech of an accompanied person, or the like. In the situation change list DB 31, presence or absence of an event to be a target of the external factor G and a parameter are accumulated.

If the external factor G is a factor that strengthens the emotion, the parameter of the external factor G may be set to “+0.1”. If the external factor G is a factor that weakens the emotion, the parameter of the external factor G may be set to “−0.1”.

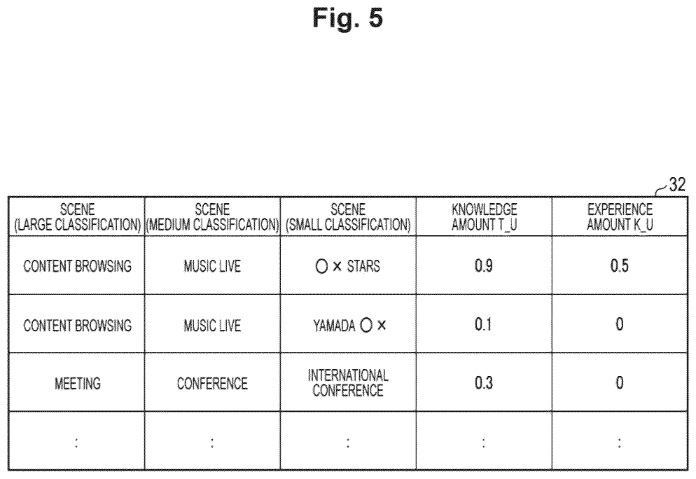

FIG. 5 is a diagram illustrating an example of content of the life log DB in a table format.

In the life log DB 32 illustrated in FIG. 1 or the like, a life log created for each user or each user attribute is accumulated. This life log is associated with (1) the large classification of the scene, (2) the medium classification of the scene, (3) the small classification of the scene, (4) the knowledge amount T_U of the user with respect to the combination of the classifications of the scene (directly, minimum classification of scene), and (5) the experience amount K_U of the user with respect to the combination of the scenes of each classification. Furthermore, each line in the life log illustrated in FIG. 5 may be referred to as a record in the life log.

In the example in FIG. 5, a life log created for a certain user that is (1) a record of a life log when the “large classification/medium classification/small classification” of the input scene is the “content browsing/music live/ox stars”, (2) a record of a life log when the “large classification/medium classification/small classification” of the input scene is “content browsing/music live/Yamada o×(artist name), and (3) a record of a life log when the “large classification/medium classification/small classification” of the input scene is “meeting/conference/international conference” is illustrated.

The knowledge amount T_U in the life log is an amount of knowledge of a user U about the scene. For example, in a case of a knowledge amount regarding a music artist named “ox stars” illustrated in FIG. 5, for example, a total value of (1) the number of purchase histories of a song of the artist or the like in a user's purchase history, (2) the number of times when the artist name is input in a user's search history and whether or not a bookmark is registered, or the like is set to T.

Then, the knowledge amount T_U may be calculated, for example, by a method for setting a ratio T/Tₘₐₓ when the maximum value among the total values of all other users, that is, a total value of a user who has the largest total value among all the users is set to Tₘₐₓ, as the knowledge amount T_U of the user U.

The experience amount K_U in the life log is the number of times when the user U actually experiences the scene. For example, in a case of an experience amount of a user about the music artist named “ox stars”, for example, a total value of (1) the number of purchase histories of a live ticket (ticket) of the artist in the user's purchase history, (2) the number of times when the user participates in the artist's live in user's schedule data, or the like is set to K.

Then, the experience amount K_U may be calculated, for example, by a method for setting a ratio K/Tₘₐₓ when the maximum value among the total values of all the users, that is, the total value of the user who has the largest total value among all the users is set to Kₘₐₓ, as the experience amount K_U of the user U.

Furthermore, the expectation degree E_U is calculated based on the expectation degree E_U calculation definition in the situation change list DB 31, using the knowledge amount T_U and the experience amount K_U in the life log. The expectation degree E_U is a strength of an expectation that the user U desires a change from the “situation A” to the “situation B”.

For example, since it is assumed that an expectation degree for a first performance of a new song by the artist named “ox stars” (refer to line with correspondence number “1” in FIG. 4) be higher as the user more deeply knows the artist and has more live experiences, the expectation degree E_U of the user U may be calculated by the following expression (1).

$$E\_U = T\_U + K\_U \qquad expression ( 1 )$$

Conversely, since an expectation degree for a band breakup declaration by the artist named “ox stars” (refer to line of correspondence number “2” in FIG. 4) is assumed to be lower as the knowledge amount and the experience amount of the user related to the artist are larger, the expectation degree E_U of the user U may be calculated by the following expression (2).

$$E\_U = 1 / ( T\_U + K\_U ) \qquad expression ( 2 )$$

In this way, the expectation degree may be calculated as an increase/decrease of the emotion, using the knowledge amount and the experience amount for each situation. Furthermore, when there is no influence on the emotion by the knowledge amount and the experience amount in a certain situation change in the life log (for example, refer to line of correspondence number “3” in FIG. 4), the expectation degree E_U is set to zero.

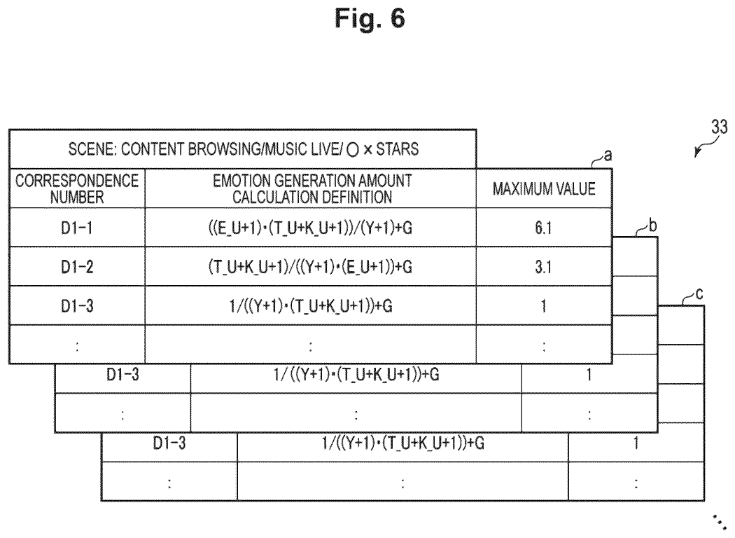

FIG. 6 is a diagram illustrating an example of content of the emotion generation amount calculation definition DB in a table format.

In the emotion generation amount calculation definition DB 33 illustrated in FIG. 1 or the like, emotion generation amount calculation definition information created for each combination of the classifications of the scene that is the emotion generation amount calculation definition, and the maximum value of the emotion generation amount are accumulated in association.

In the example in FIG. 6, a plurality of types of emotion generation amount calculation definition information is illustrated including (1) emotion generation amount calculation definition information (reference a in FIG. 6) when the “large classification/medium classification/small classification” of the input scene is “content browsing/music live/ox stars” (refer to FIG. 5), (2) emotion generation amount calculation definition information (reference b in FIG. 6) when the “large classification/medium classification/small classification” of the input scene is “content browsing/music live/Yamada ox” (refer to FIG. 5), and (3) emotion generation amount calculation definition information (reference c in FIG. 6) when the “large classification/medium classification/small classification” of the input scene is “meeting/conference/international conference” (refer to FIG. 5).

Furthermore, each line in the emotion generation amount calculation definition information illustrated in FIG. 6 may be referred to as a record in the emotion generation amount calculation definition information.

Furthermore, a correspondence number is assigned to each line in the emotion generation amount calculation definition information. Correspondence numbers “D1-1”, “D1-2”, “D1-3”, . . . assigned to the respective lines in the emotion generation amount calculation definition information illustrated in FIG. 6 correspond to the correspondence numbers “1”, “2”, “3”, . . . assigned to the respective lines in the situation change list information illustrated in FIG. 4.

The emotion generation amount calculation definition is a calculation definition of a prediction value indicating how strong the emotion of the user is created in the scene, based on some or all of the prediction degree Y, the expectation degree E_U, the knowledge amount T_U, the experience amount K_U, and the external factor G. In the emotion generation amount calculation definition DB 33, the maximum value of a value that can be taken by each definition used to easily express a degree of a calculated value of the emotion generation amount is accumulated.

For example, when it is assumed that the emotion generation amount of excited feeling in the first performance of the new song by the music artist named “ox stars” illustrated in FIG. 6 or the like (for example, refer to line of correspondence number “1” in FIG. 4) be higher as the first performance of the new song is not an unexpected event (for example, prediction degree Y in situation change list illustrated in FIG. 4 is smaller), be higher as the expectation of the user (for example, expectation degree E_U in situation change list illustrated in FIG. 4) is larger, and be higher as the artist is known more deeply (for example, knowledge amount T_U and experience amount K_U in life log illustrated in FIG. 5 are large), the emotion generation amount is calculated, for example, by “((E_U+1)·(T_U+K_U+1))/(Y+1)”.

Furthermore, if the external factor G is considered, the calculation formula of the emotion generation amount can be defined as “((E_U+1)·(T_U+K_U+1))/(Y+1)+G” (refer to line of correspondence number “D1-1” illustrated in FIG. 6). Furthermore, “+1” in “E_U+1” in the calculation formula is a value that prevents a denominator or numerator from being zero. Furthermore, in a case where the expectation degree E_U is less than zero, “E_U+1” in the calculation formula may be changed to “E_U”.

Specifically, when excited feeling of the user at the time of the first performance of the new song by “ox stars” is calculated as the emotion generation amount, from the examples illustrated in FIGS. 4 to 6, the emotion generation amount is calculated by the following expression (3), as assuming “prediction degree Y=0.3”, “expectation degree E_U=1.4”, “knowledge amount T_U=0.9”, “experience amount K_U=0.5”, and “external factor G=+0.1”.

$$Emotion generation amount = ( 2.4 \cdot 2.4 ) / 1.3 + 0.1 \approx 4.5 \qquad expression ( 3 )$$

A ratio with respect to the maximum value of the emotion generation amount, in accordance with a calculation result of the emotion generation amount, after the emotion generation amount calculation definition DB 33 has been constructed may be calculated as in the following expression (4).

$$Ratio = 4.5 / 6.1 \approx 0.74 = 74 [ \% ] \qquad expression ( 4 )$$

The external factor G is not essential for the various DBs, and the external factor G may be removed from various DBs. In this case, the emotion generation amount calculation definition in the emotion generation amount calculation definition DB 33 may include some or all of the prediction degree Y, the expectation degree E_U, the knowledge amount T_U, and the experience amount K_U.

Furthermore, in the situation change list DB 31 and the emotion generation amount calculation definition DB 33, only one of the knowledge amount T_U and the experience amount K_U may be managed. For example, when only the knowledge amount T_U of the knowledge amount T_U and the experience amount K_U is managed in the life log DB 32, the expectation degree E_U calculation definition in the situation change list DB 31 may include only the knowledge amount T_U.

Furthermore, when only the knowledge amount T_U of the knowledge amount T_U and the experience amount K_U is managed in this way, the emotion generation amount calculation definition in the emotion generation amount calculation definition DB 33 may include some or all of at least the prediction degree Y, the expectation degree E_U, and the knowledge amount T_U, among the prediction degree Y, the expectation degree E_U, the knowledge amount T_U, and the external factor G.

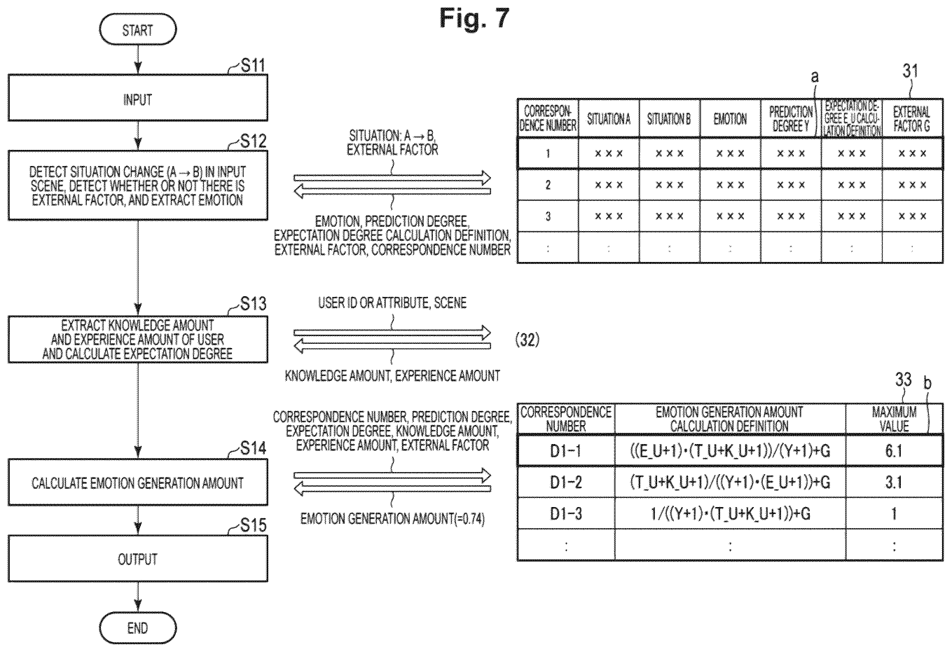

FIG. 7 is a diagram illustrating an example of a procedure of a processing operation by the emotion estimation apparatus according to the first embodiment of the present invention.

After various DBs are constructed, the emotion calculation unit 20 executes the following processing S11 to S13, on each classification of the scene and the user attribute, input by the user.

### Processing S11

The emotion calculation unit 20 detects a change from the “situation A” (for example, “known song”) to the situation B (for example, “first performance of new song”), concurrently detects whether or not there is the external factor G (for example, “detected=+0.1”), and specifies situation change list information regarding the combination of the classifications of the input scene, from among the situation change list information related to each scene, accumulated in the situation change list DB 31.

The emotion calculation unit 20 specifies a record (reference a in FIG. 7) including a combination of the “situation A”, the “situation B”, and the external factor G detected above, in the specified situation change list information.

The emotion calculation unit 20 extracts (1) an emotion “excited” created by the change in the situation, (2) a prediction degree “0.3”, and (3) an expectation degree E_U calculation definition, to be associated with the “situation A”, the “situation B”, and the external factor G, in the specified record.

At the same time as this extraction, a correspondence number of the specified record (for example, refer to record with correspondence number “1” indicated by reference a in FIG. 7) in the situation change list DB 31 is determined.

If the large classification of the input scene is “content browsing”, the change from the “situation A” to the “situation B” may be detected, for example, by “Extraction of Actors, Actions and Events from Sports Video by Integrating Linguistic and Image Information, Nitta et al., Technical report of IEICE, PRMU, pattern recognition and media understanding, Vol. 99, No. 709, pp. 75 to 82, 2000.”, “A study on selecting scenes that match the news contents for news video summarization, ZHANG et al., Technical report of IEICE, vol. 115, no. 76, MVE2015-7, pp. 57 to 58, 2015.”, or the like. When the position information is included in the large classification of the scene, a staying place is extracted from a mobile terminal as a situation.

Whether or not there is the external factor G is detected as whether or not there is a situation corresponding to the external factor in the situation change list DB 31, as an element that affects a variation of the strength of the emotion occurred due to the change from the “situation A” to the “situation B”, detected above.

For example, whether or not there is the external factor G is detected based on a matching degree between information sent before the “situation B” occurs, such as a speech of an artist or a production in the large classification “content browsing” of the input scene, acquired through voice recognition or image recognition, with the “situation B” or the like. Alternatively, whether or not there is the external factor G is detected from a search history, a content browsing history, or the like related to the artist by the user, before the “content browsing”.

At that time, the number of parameters of the external factor may be increased/decreased in accordance with a matching degree with the situation or a history degree. As an example of a specific effect, for example, when it is detected that a user has obtained information regarding a surprise in a live, immediately before the surprise, the value of the external factor G is increased, and an increase in an excitement degree of the user knowing the surprise is reflected on an estimation value of the emotion generation amount.

### Processing S12

The emotion calculation unit 20 specifies a life log related to the input user attribute, among the life logs accumulated in the life log DB 32, specifies a record related to a combination of the classifications of the scene input by the user in the life log, and extracts a knowledge amount and an experience amount of the user in the specified record. Then, the emotion calculation unit 20 calculates an expectation degree E_U, by substituting these extraction results into the expectation degree E_U calculation definition in the record specified in the processing S11 in the situation change list DB 31, under the condition of the input scene.

### Processing S13

The emotion calculation unit 20 specifies situation change list information related to the combination of the classifications of the input scene, from among the emotion generation amount calculation definition information of each scene accumulated in the emotion generation amount calculation definition DB 33 and specifies a record (for example, refer to reference b in FIG. 7) with a correspondence number (for example, correspondence number “D1-1” in FIG. 7) corresponding to the correspondence number (for example, correspondence number “1” in FIG. 7) determined in the processing S11, in the specified situation change list information.

The emotion calculation unit 20 calculates the emotion generation amount (for example, 0.74 (74%) illustrated in FIG. 7) that is the strength of the emotion generated by the user, by substituting the prediction degree Y extracted in the processing S11, the event and the parameter of the external factor G, the knowledge amount T_U extracted in the processing S12, the experience amount K_U, and the expectation degree E_U calculated in the processing S12, in the situation detected in the processing S11, into the emotion generation amount calculation definition included in the record (for example, refer to reference b in FIG. 7) with the correspondence number (for example, correspondence number “D1-1” in FIG. 7) corresponding to the specified correspondence number (for example, correspondence number “1” in FIG. 7) determined in the processing S11, in the emotion generation amount calculation definition DB 33.

The emotion calculation unit 20 outputs this calculation result as a message (for example, “excited with strength of 74%” illustrated in FIG. 7) or the like to the user.

The output of the emotion generation amount includes the created emotion and the magnitude thereof. In a case where the output emotion is not one type of emotion but a plurality of types of emotions, that is, the plurality of types of emotions may be output based on the combination of the “situation A” and the “situation B”. For example, “excited with strength of 74%” in a form corresponding to the “situation A”, “exciting with strength of 55%” in a form corresponding to the “situation B, or the like, the emotion created for each of the plurality of types of emotions and the magnitude thereof are output in an associated manner.

Note that a method for outputting the emotion generation amount may be either one of a text format as “excited with strength of 74%” or, for example, a vector format as “(excited, 74)”. It is sufficient that the magnitudes for the plurality of types of emotions be written in correspondence with each other. Furthermore, in a case where the plurality of types of emotions is output, only an emotion with the largest value may be output.

In one embodiment of the present invention, a case where a magnitude of an emotion is calculated as a ratio (%) is described. However, the magnitude of the emotion may be expressed by a negative value. As an example of the output of the emotion, for example, the emotion may be output as an expression using a text and a sentence like “excited 90%”, a pictogram, an illustration, various symbols and codes corresponding thereto, or a combination thereof. It is sufficient that a method for expressing the output emotion be to express the emotion in accordance with characteristics of media.

For example, in the present embodiment, the created emotion and the magnitude thereof are identified, and it is possible to convert the emotion in a content format such as a video, a voice, or an image, and to present the emotion on a smart phone screen, a television screen, a personal computer screen, or a screen of a game machine or to output as a voice. By switching a type of the voice or a method for displaying the video depending on the type of the emotion, it is possible to change an expression of content so as to give an arbitrary emotion expression effect.

Furthermore, in the present embodiment, by converting and expressing the strength of the emotion into and as an illustration type, a size, a color tone, a degree of decoration, a tone of a reading voice, a volume, a size of a symbol bar, or a type, it is possible to tell the type and the magnitude of the emotion created by the user to the user in an easily identifiable manner.

### Second Embodiment

Next, a second embodiment will be described. Detailed description about components in the embodiment similar to those in the first embodiment is omitted.

The second embodiment is different from the first embodiment in the following points.

In the first embodiment, after various DBs are constructed, the “scene” and the “attribute” of the user are input by the user. However, in the second embodiment, after various DBs are constructed, the “attribute” of the user and an “emotion desired to be shared with other person” by the user are input by the user.

Processing target ranges in the situation change list DB 31 and the emotion generation amount calculation definition DB 33 in the first embodiment are different from those in the second embodiment. For example, in the first embodiment, only information regarding the scene input by the user in the situation change list DB 31 and the emotion generation amount calculation definition DB 33 is a processing target. However, in the second embodiment, situation change list information related to all scenes accumulated in the situation change list DB 31 and emotion generation amount calculation definition information related to all the scenes accumulated in the emotion generation amount calculation definition DB 33 are processing targets.

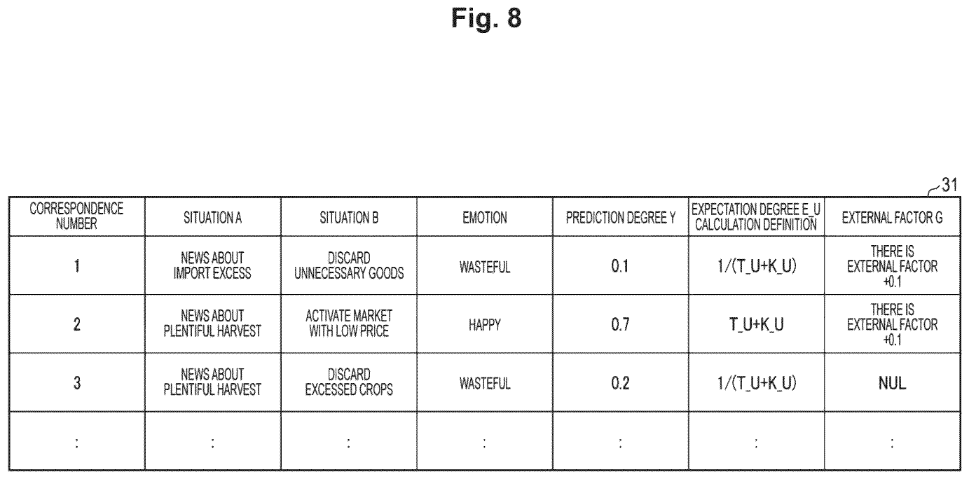

FIG. 8 is a diagram illustrating an example of content of the situation change list DB according to the second embodiment of the present invention in a table format.

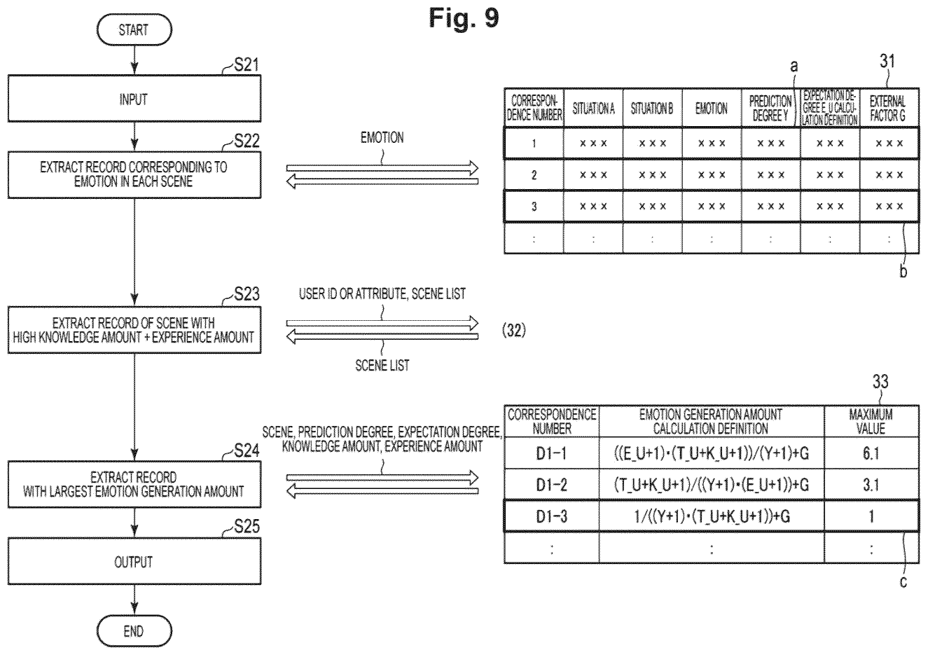

FIG. 9 is a diagram illustrating an example of a procedure of a processing operation by an emotion estimation apparatus according to the second embodiment of the present invention.

In the second embodiment, for example, for the purpose of “telling a feeling to people in a different culture who is unfamiliar with a feeling of “wasteful””, a scene/attribute input unit 10 receives an input of information indicating (1) an attribute of a user and (2) an emotion that the user wants to know and a type of an emotion in a designated situation, through an input operation on a UI screen by the user. An emotion calculation unit 20 executes the following processing S21 to S23 on the input information.

### Processing S21

The emotion calculation unit 20 specifies a single or a plurality of records including the input emotion, from among the records of the situation change list information related to all the scenes accumulated in the situation change list DB 31 and extracts a scene related to the specified record and a list of correspondence numbers included in the record.

For example, when “wasteful” is input as the emotion, regardless of the type of the scene, for example, a single or a plurality of records (for example, refer to references a and b in FIG. 9) including the emotion “wasteful” (refer to FIG. 8) is specified from the situation change list information, and a list of scenes (large classification/medium classification) (for example “content browsing/news”) related to the specified record, a list of correspondence numbers (for example, “1”, “3”, . . . ), and the like are extracted.

### Processing S22

The emotion calculation unit 20 specifies a life log related to the user attribute input by the user, from among the life logs accumulated in the life log DB 32 and specifies one or a plurality of records related to the scene extracted in S21, in this life log. The emotion calculation unit 20 specifies a single or a plurality of records satisfying a predetermined condition, for example, including the knowledge amount T_U and/or the experience amount K_U that are equal to or more than a predetermined threshold and, from among the specified records, and extracts a list of scenes of each classification, included in the specified record.

For example, the emotion calculation unit 20 specifies a single or a plurality of records of which at least one of the knowledge amount T_U and the experience amount K_U is equal to or more than 0.7, from among the single or the plurality of records related to the scene extracted in S21, in the life log and/or a single or a plurality of records of which a total of the knowledge amount T_U and the experience amount K_U exceeds 1.5 and extracts a scene of each classification, included in the record.

### Processing S23

The emotion calculation unit 20 specifies a single or a plurality of records corresponding to the correspondence number extracted in the processing S21, from the situation change list information related to the scene extracted in the processing S22, from the situation change list information accumulated in the situation change list DB 31, under a condition of the same scene and extracts parameters of a prediction degree Y, an expectation degree E_U calculation definition, and an external factor G included in the record, for each specified record.

The emotion calculation unit 20 extracts the knowledge amount T_U and the experience amount K_U included in each of the single or the plurality of records specified in the processing S22, from each record of the life log accumulated in the life log DB 22.

The emotion calculation unit 20 calculates an expectation degree E_U related to the record extracted from the situation change list DB 31, by substituting the knowledge amount T_U and the experience amount K_U extracted from the life log DB 22 into the expectation degree E_U calculation definition of the record extracted from the situation change list DB 31, under the condition of the same scene.

The emotion calculation unit 20 specifies a single or a plurality of records related to the correspondence number (for example, “D-1” in FIG. 9) corresponding to the correspondence number (for example, “1” in FIG. 9) extracted in the processing S21, from the records of the emotion generation amount calculation definition information accumulated in the emotion generation amount calculation definition DB 33, under the condition of the same scene, and extracts an emotion generation amount calculation definition included in the specified record.

The emotion calculation unit 20 calculates the emotion generation amount by substituting (1) the prediction degree Y and an event and a parameter of the external factor G extracted from the record related to the extracted correspondence number (for example, “1” in FIG. 9), accumulated in the situation change list DB 31, (2) the calculated expectation degree E_U, and (3) the knowledge amount T_U and the experience amount K_U extracted from the life log DB 32, into the extracted emotion generation amount calculation definition, under the condition of the same scene.

Then, when the number of records specified from the emotion generation amount calculation definition DB 33 is plural, the emotion calculation unit 20 calculates an emotion generation amount for each of the plurality of records, specifies a single or a plurality of records (for example, refer to reference c in FIG. 9) including the emotion generation amount calculation definition used to calculate the largest emotion generation amount, from among these records, and extracts a correspondence number (for example, correspondence number “D1-3” in FIG. 9) included in the record.

The emotion calculation unit 20 specifies a record corresponding to the extracted correspondence number, from the situation change list DB 31 and outputs a scene, the “situation A”, the “situation B”, and the emotion included in the record to the user.

When the output information regarding the emotion or the like includes a plurality of pieces of information, that is, when a plurality of records related to the same and the largest emotion generation amount is extracted, these pieces of information is presented together, or only one piece of information extracted first is presented, for example.

An expression method when the information regarding each situation and the emotion is output to the user is arbitrary, and for example, the information may be presented to the user by an expression method such as to fit an output result into a fixed phrase using words described in the “situation A” and the “situation B” and displaying the output result as sentences, like a “situation where an excess of a plenty of crops is discarded” illustrated in FIG. 9.

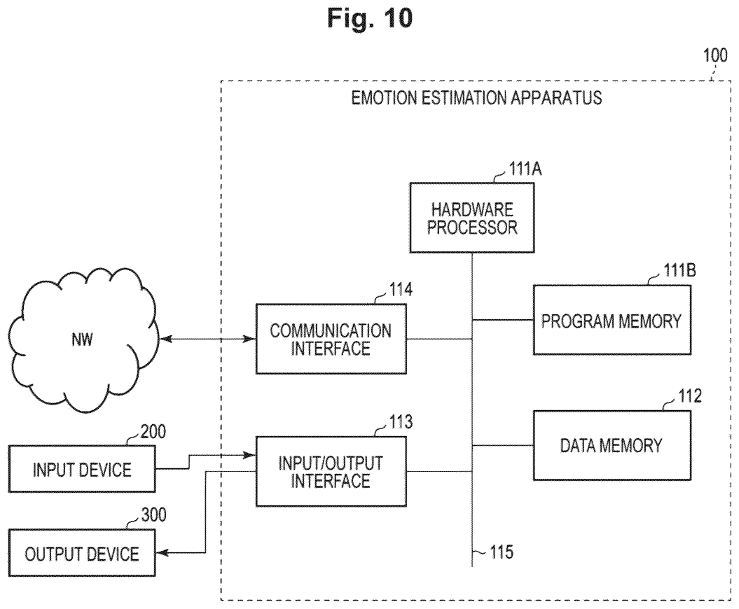

FIG. 10 is a block diagram illustrating an example of a hardware configuration of the emotion estimation apparatus according to the embodiment of the present invention.

In the example illustrated in FIG. 10, the emotion estimation apparatus 100 according to the embodiment includes, for example, a server computer or a personal computer, and includes a hardware processor 111A such as a central processing unit (CPU). Then, the hardware processor 111A is connected to a program memory 111B, a data memory 112, an input/output interface 113, and a communication interface 114 via a bus 115.

The communication interface 114 includes, for example, one or more wireless communication interface units, and enables transmission and reception of information to and from a communication network NW. As a wireless interface, for example, an interface is used in which a low-power wireless data communication standard such as a wireless local area network (LAN) is adopted.

The input/output interface 113 is connected to an input device 200 and an output device 300 that are attached to the emotion estimation apparatus 100 and used by the user or the like.

The input/output interface 113 performs processing of retrieving operation data input by the user or the like through the input device 200 such as a keyboard, a touch panel, a touchpad, or a mouse, and outputting output data to the output device 300 including a display device using liquid crystal, organic electro luminescence (EL), or the like to display the output data. Note that, as the input device 200 and the output device 300, a device built in the emotion estimation apparatus 100 may be used, or an input device and an output device of another information terminal that can communicate with the emotion estimation apparatus 100 via the network NW may be used.

The program memory 111B is used as a non-transitory tangible storage medium, for example, as a combination of a non-volatile memory on which writing and reading can be performed as necessary, such as a hard disk drive (HDD) or a solid state drive (SSD), and a non-volatile memory such as a read only memory (ROM), and stores programs necessary for executing various types of control processing and the like according to the one embodiment.

The data memory 112 is used as a tangible storage medium, for example, as a combination of a non-volatile memory and a volatile memory such as a random access memory (RAM), and is used to store various types of data acquired and created in a process in which various types of processing is performed.

The emotion estimation apparatus 100 according to one embodiment of the present invention may be configured as a data processing device including the scene/attribute input unit 10, the emotion calculation unit 20, the output unit 40, and the DB input unit 50 illustrated in FIG. 1, as processing functional units by software.

A storage device used as a working memory or the like by each unit of the emotion estimation apparatus 100 and a storage device used as the storage unit 30 may be configured by using the data memory 112 illustrated in FIG. 10. Here, these configured storage areas are not essential configurations in the emotion estimation apparatus 100, and may be areas provided in, for example, an external storage medium such as a universal serial bus (USB) memory or a storage device such as a database server provided in a cloud.

Each processing functional unit in each unit of the scene/attribute input unit 10, the emotion calculation unit 20, the output unit 40, and the DB input unit 50 may be implemented by causing the hardware processor 111A to read and execute a program stored in the program memory 111B. Some or all of those processing functional units may be formed in various other modes including an integrated circuit such as an application specific integrated circuit (ASIC) or a field-programmable gate array (FPGA).

In addition, the method described in each embodiment can be stored as a program (software means) that can be executed by a computing machine (computer), for example, in a recording medium such as a magnetic disk (such as a floppy (registered trademark) disk or a hard disk), an optical disc (such as a CD-ROM, a DVD, or a MO), or a semiconductor memory (such as a ROM, a RAM, or a flash memory), and can be distributed by being transmitted through a communication medium. Note that the programs stored in the medium also include a setting program for configuring, in the computing machine, software means (including not only an execution program but also a table and a data structure) to be executed by the computing machine. The computing machine that implements the present device executes the above-described processing by reading the programs recorded in the recording medium, constructing the software means by the setting program as needed, and controlling operation by the software means. Note that the recording medium in the present specification is not limited to a recording medium for distribution, and includes a storage medium such as a magnetic disk or a semiconductor memory provided inside the computing machine or in a device connected via a network.

Note that the present invention is not limited to the above embodiments, and various modifications can be made in the implementation stage without departing from the gist of the invention. In addition, the embodiments may be implemented in appropriate combination, and in this case, a combined effect can be obtained. Furthermore, the above embodiment includes various inventions, and various inventions can be extracted by a combination selected from a plurality of disclosed components. For example, even if some components are deleted from all the components described in the embodiment, a configuration from which the components have been deleted can be extracted as an invention, as long as the problem can be solved and the effects can be achieved.

### REFERENCE SIGNS LIST

100 emotion estimation apparatus
10 scene/attribute input unit
20 emotion calculation unit
30 storage unit
31 situation change list DB
32 life log DB
33 emotion generation amount calculation definition DB
40 output unit
50 DB input unit
51 scene creation/input unit
52 situation and emotion data input (acquisition) unit
53 prediction degree input (acquisition) unit
54 expectation degree definition input unit
55 knowledge and experience data acquisition unit
56 calculation definition input unit
57 parameter designation unit

1. An emotion estimation apparatus that estimates an emotion generated by a user, using first management information in which a first situation, a second situation changed from the first situation, emotion information representing an emotion expression of the user when the first situation changes to the second situation, a prediction degree indicating a magnitude of a possibility that the first situation changes to the second situation, and an expectation degree indicating a magnitude of an expectation of the user for the change from the first situation to the second situation are managed together with information indicating a scene related to the user, second management information in which at least one of a knowledge amount indicating an amount of knowledge of the user for the scene and an experience amount indicating an amount of experience of the user for the scene is managed, and third management information in which a calculation definition of an emotion generation amount indicating a strength of an emotion expression generated by the user when the first situation changes to the second situation, based on the prediction degree, the expectation degree, and the second management information is managed together with the information indicating the scene, the emotion estimation apparatus comprising:
an estimation unit configured to extract the prediction degree corresponding to the scene currently related to the user and the expectation degree, from the first management information, extract the second management information corresponding to the currently related scene, and estimate the emotion generation amount indicating the strength of the emotion expression generated by the user when the first situation changes to the second situation, on the basis of the extracted results and the calculation definition of the emotion generation amount corresponding to the scene currently related to the user.

2. The emotion estimation apparatus according to claim 1, wherein
the first management information includes a variation element that is an element that affects a variation of the emotion generation amount,
the calculation definition of the emotion generation amount is a calculation definition based on the prediction degree, the expectation degree, the fluctuation element, and the second management information, and
the estimation unit estimates the emotion generation amount indicating the strength of the emotion expression generated from the user, on the basis of the extracted results and the calculation definition of the emotion generation amount.

3. The emotion estimation apparatus according to claim 1, wherein
the expectation degree is calculated on the basis of at least one of the knowledge amount of the user for the scene related to the user and the experience amount indicating the amount of the experience of the user for the scene related to the user.

4. An emotion estimation apparatus that estimates an emotion generated by a user, using first management information in which a first situation, a second situation changed from the first situation, emotion information representing an emotion expression of the user when the first situation changes to the second situation, a prediction degree indicating a magnitude of a possibility that the first situation changes to the second situation, and an expectation degree indicating a magnitude of an expectation of the user for the change from the first situation to the second situation are managed together with information indicating a scene related to the user, second management information in which at least one of a knowledge amount indicating an amount of knowledge of the user for the scene and an experience amount indicating an amount of experience of the user for the scene is managed, and third management information in which a calculation definition of an emotion generation amount indicating a strength of an emotion expression generated by the user when the first situation changes to the second situation, based on the prediction degree, the expectation degree, and the second management information is managed together with the information indicating the scene, the emotion estimation apparatus comprising:
an estimation unit configured to extract the prediction degree corresponding to emotion information representing an emotion expression that the user desires to share with other person and the expectation degree, from the first management information, extract the information indicating the scene managed together with the extracted results in the first management information, extract management information in which at least one of the knowledge amount and the experience amount in the second management information corresponding to the extracted scene satisfies a condition, and estimate the emotion generation amount indicating the strength of the emotion expression generated by the user, on the basis of the extracted prediction degree, the expectation degree, the extracted second management information, and the calculation definition of the emotion generation amount.

5. A emotion estimation method performed by the emotion estimation apparatus according to claim 1, the emotion estimation method comprising:
by an estimation unit of the emotion estimation apparatus, extracting the prediction degree corresponding to the scene currently related to the user and the expectation degree, from the first management information, extracting the second management information corresponding to the currently related scene, and estimating the emotion generation amount indicating the strength of the emotion expression generated by the user when the first situation changes to the second situation, on the basis of the extracted results and the calculation definition of the emotion generation amount corresponding to the scene currently related to the user.

6. A emotion estimation method performed by the emotion estimation apparatus according to claim 4, the emotion estimation method comprising:
by an estimation unit of the emotion estimation apparatus, extracting the prediction degree corresponding to emotion information representing an emotion expression that the user desires to share with other person and the expectation degree, from the first management information, extracting the information indicating the scene managed together with the extracted results in the first management information, extracting management information in which at least one of the knowledge amount and the experience amount in the second management information corresponding to the extracted scene satisfies a condition, and estimating the emotion generation amount indicating the strength of the emotion expression generated by the user, on the basis of the extracted prediction degree, the expectation degree, the extracted second management information, and the calculation definition of the emotion generation amount.

7. A non-transitory computer-readable medium having computer-executable instructions that, upon execution of the instructions by a processor of a computer, cause the computer to function as each unit of the emotion estimation apparatus according to claim 1.
